(19) United States
(12) Patent Application Publication
(10) Pub. No.: US 2021/0040278 A1
(43) Pub. Date: Feb. 11, 2021

(54) METHOD FOR MANUFACTURING ANISOTROPIC POLYMER PARTICLES

(71) Applicant: National Chiao Tung University, Hsinchu City (TW)

(72) Inventors: Jiun-Tai Chen, Hsinchu City (TW); Hsiao-Fan Tseng, Kaohsiung City (TW); Yu-Jing Chiu, Taichung City (TW)

(21) Appl. No.: 16/535,913

(22) Filed: Aug. 8, 2019

(51) Int. Cl. C08J 5/12; C08J 3/12

(52) U.S. Cl. CPC C08J 5/122; C08J 5/121; C08J 2333/12; C08J 2325/06; C08J 3/12

(57) ABSTRACT

A method for manufacturing anisotropic polymer particles includes the steps of: (a) preparing on a substrate a polymeric composite which includes a film of a first polymer and a plurality of microspheres of a second polymer, (b) subjecting the polymeric composite on the substrate to a first solvent vapor annealing treatment in a vapor atmosphere of a first solvent, and (c) after step b), subjecting the polymeric composite on the substrate to a second solvent vapor annealing treatment in a vapor atmosphere of a second solvent so as to transform the microspheres of the second polymer into the anisotropic polymer particles.

### FIELD

The disclosure relates to a method for manufacturing anisotropic polymer particles, and more particularly to a method for manufacturing anisotropic polymer particles using a two-step solvent on-film annealing technique.

### BACKGROUND

In recent years, anisotropic polymer particles have received growing attention because of their unique properties and morphologies. The anisotropic polymer particles can be applied to a variety of areas, such as drug delivery, optical traps, and e-paper display. Until now, a few techniques to produce the anisotropic polymer particles have been reported. However, most of the proposed techniques are complicated or require the addition of surfactants, which restrain possible applications of the anisotropic polymer particles.

A simple and facile method to prepare the anisotropic polymer particles (i.e., a thermal annealing strategy) has been previously reported, in which polymer microspheres are annealed on polymer films at elevated temperatures. Although the anisotropic polymer particles have been successfully made, the functions of the thus prepared polymer particles might be altered because of thermal degradation problems at elevated annealing temperatures.

### SUMMARY

Therefore, an object of the disclosure is to provide a simple and versatile method to prepare anisotropic polymer particles that may have different shapes.

According to the disclosure, there is provided a method for manufacturing anisotropic polymer particles, which includes the steps of:

a) preparing on a substrate a polymeric composite which includes a film of a first polymer formed on the substrate and a plurality of microspheres of a second polymer deposited on the film of the first polymer, the second polymer being different from the first polymer;

b) subjecting the polymeric composite on the substrate to a first solvent vapor annealing treatment in a vapor atmosphere of a first solvent, which is a solvent for the first polymer and which is a non-solvent for the second polymer, to permit the first polymer to swell and partially cover the microspheres of the second polymer; and

c) after step b), subjecting the polymeric composite on the substrate to a second solvent vapor annealing treatment in a vapor atmosphere of a second solvent, which is a solvent for the second polymer and which is a non-solvent for the first polymer, to permit the second polymer to swell and cover back the film of the first polymer, so as to transform the microspheres of the second polymer into the anisotropic polymer particles.

### BRIEF DESCRIPTION OF THE DRAWINGS

Other features and advantages of the disclosure will become apparent in the following detailed description of the embodiment(s) with reference to the accompanying drawings, of which:

FIG. 1 is a flow diagram illustrating a method for manufacturing anisotropic polymer particles according to the disclosure;

FIG. 2 shows a graphical illustration of consecutive steps of manufacturing the anisotropic polymer particles of Example 1, optical microscopic (OM) images and scanning electron microscopic (SEM) images of a polystyrene/polymethyl methacrylate (PS/PMMA) composite of Example 1 before first and second solvent vapor annealing treatments, at the end of the first solvent vapor annealing treatment, and at the end of the second solvent vapor annealing treatment, and the OM images and the SEM images of the anisotropic polymer particles of Example 1;

FIG. 3 depicts the SEM images of the PS/PMMA composites at the end of the second solvent vapor annealing treatment in Examples 2 to 5, and the SEM images of the anisotropic polymer particles of Examples 2 to 5;

FIG. 4 depicts the SEM images of the PS/PMMA composites at the end of the second solvent vapor annealing treatment in Examples 6 and 7, and the SEM images of the anisotropic polymer particles of Examples 6 and 7; and

FIG. 5 depicts the SEM images of the PS particles of Comparative Example 1.

### DETAILED DESCRIPTION

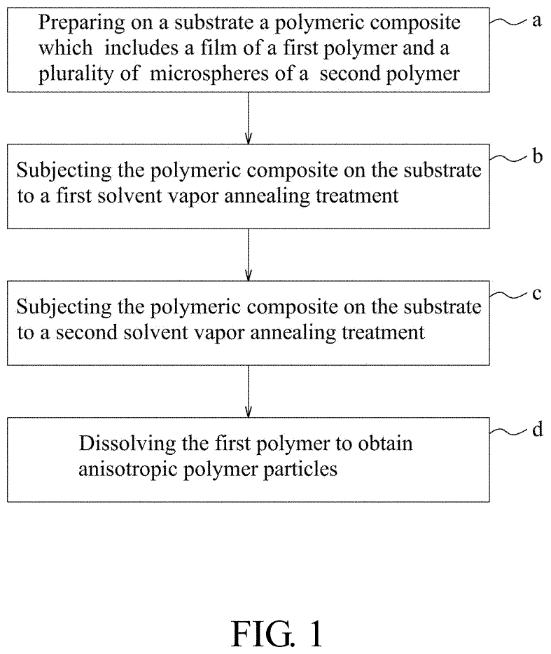

Referring to FIG. 1, a method for manufacturing anisotropic polymer particles according to an embodiment of the disclosure includes the steps of:

a) preparing on a substrate a polymeric composite which includes a film of a first polymer formed on the substrate and a plurality of microspheres of a second polymer deposited on the film of the first polymer, the second polymer being different from the first polymer;

b) subjecting the polymeric composite on the substrate to a first solvent vapor annealing treatment in a vapor atmosphere of a first solvent, which is a solvent for the first polymer and which is a non-solvent for the second polymer, to permit the first polymer to swell and partially cover the microspheres of the second polymer;

c) after step b), subjecting the polymeric composite on the substrate to a second solvent vapor annealing treatment in a vapor atmosphere of a second solvent, which is a solvent for the second polymer and which is a non-solvent for the first polymer, to permit the second polymer to swell and cover back the film of the first polymer, so as to transform the microspheres of the second polymer into the anisotropic polymer particles; and

d) dissolving the first polymer with a third solvent to remove the film of the first polymer so as to obtain the anisotropic polymer particles.

In certain embodiments, the first polymer and the second polymer are independently selected from polystyrene, polymethyl methacrylate, polylactide, polycaprolactone, polyvinylpyrrolidone, poly(lactic-co-glycolic acid), and combinations thereof.

In certain embodiments, the first polymer is polymethyl methacrylate and the second polymer is polystyrene.

In certain embodiments, the first solvent is selected from acetic acid, diethyl sulfate, nitroethane, ethanolamine, and combinations thereof.

In certain embodiments, the first solvent is acetic acid.

In certain embodiments, the second solvent is selected from cyclohexane, n-octane, n-dodecane, methylcyclohexane, benzene, o-xylene, ethyl benzene, and combinations thereof.

In certain embodiments, the second solvent is cyclohexane.

In certain embodiments, the third solvent is selected from acetic acid, diethyl sulfate, nitroethane, ethanolamine, and combinations thereof.

In certain embodiments, the third solvent is acetic acid.

In certain embodiments, step a) is implemented by evaporation, spin coating, blade coating, spray coating, slot die coating, inject coating, or combinations thereof.

In certain embodiments, the microspheres of the second polymer are prepared by emulsion polymerization, dispersion polymerization, suspension polymerization, microfluidics, non-solvent precipitation, templating, electrospraying, thermospraying, or combinations thereof.

In certain embodiments, in step a), the microspheres of the second polymer deposited on the film of the first polymer are arranged in a discrete sphere pattern, a single-layered aggregated sphere array, or a multi-layered aggregated sphere array.

In certain embodiments, in step a), the film of the first polymer has a thickness ranging from 10 nm to 100 μm.

In certain embodiments, in step a), the microspheres of the second polymer have an average size ranging from 10 nm to 100 μm.

In certain embodiments, in step a), the substrate is selected from a glass substrate, a silicon substrate, and a combination thereof.

In certain embodiments, each of the first and second solvent vapor annealing treatments is implemented in a chamber.

In certain embodiments, in step b), the first solvent vapor annealing treatment is implemented at a first annealing temperature ranging from 0° C. to 150° C. for a first annealing time period of up to 48 hours. When the first annealing temperature is lower than 0° C., the vapor pressure of the first solvent in the chamber may be too low for proper implementation of the first solvent vapor annealing treatment. When the first annealing temperature is higher than 150° C., the vapor pressure of the first solvent in the chamber may be too high for proper implementation of the first solvent vapor annealing treatment. When the first annealing time period is more than 48 hours, the anisotropic polymer particles may not be obtained.

In certain embodiments, in step c), the second solvent vapor annealing treatment is implemented at a second annealing temperature ranging from 0° C. to 150° C. for a second annealing time period of up to 48 hours. When the second annealing temperature is lower than 0° C., the vapor pressure of the second solvent in the chamber may be too low for proper implementation of the second solvent vapor annealing treatment. When the second annealing temperature is higher than 150° C., the vapor pressure of the second solvent in the chamber may be too high for proper implementation of the second solvent vapor annealing treatment. When the second annealing time period is more than 48 hours, the anisotropic polymer particles may not be obtained.

The morphology changes of the polymeric composite of the first and second polymers during the first and second solvent vapor annealing treatments are caused by not only surface tensions but also interfacial tensions of the first and second polymers that are swollen by the vapors of the first and second solvents. When the microspheres of the second polymer and the film of the first polymer are annealed in the vapor atmosphere of the first solvent during the first solvent vapor annealing treatment, the swelling degree for the microspheres of the second polymer is much less than that for the film of the first polymer due to that the first solvent is a solvent for the first polymer but is a non-solvent for the second polymer. The surface tension of the microspheres of the second polymer with the first solvent vapor annealing treatment is similar to that of the microspheres of the second polymer without the first solvent vapor annealing treatment. The surface tension of the film of the first polymer with the first solvent vapor annealing treatment is affected more significantly by the presence of the first solvent. Therefore, in the first solvent vapor annealing treatment, the film of the first polymer is selectively swollen by the first solvent, and gradually climbs up and coats the surfaces of the microspheres of the second polymer, while the microspheres of the second polymer are maintained in a spherical shape.

In the second solvent vapor annealing treatment, the polymeric composite is annealed in the vapor atmosphere of the second solvent, which is a solvent for the second polymer but is a non-solvent for the first polymer. Therefore, the second polymer can cover back the film of the first polymer while the morphology of the film of the first polymer is maintained, so as to transform the microspheres of the second polymer into the anisotropic polymer particles.

By using the method for manufacturing anisotropic polymer particles according to the disclosure, the anisotropic polymer particles having unique and complicated shapes, such as half-eaten-peach-shaped, snowman-shaped, and bowler-hat-shaped morphologies can be successfully prepared. The strategy of using the vapors of the first and second solvents not only solves the thermal degradation problem of polymers at elevated annealing temperatures, which is often encountered in prior art, but also have the advantage of selectively annealing different components (i.e., the first and second polymers) of the polymeric composite in sequence, which is inaccessible by other approaches.

Examples of the disclosure will be described hereinafter. It is to be understood that these examples are exemplary and explanatory and should not be construed as a limitation to the disclosure.

### Example 1

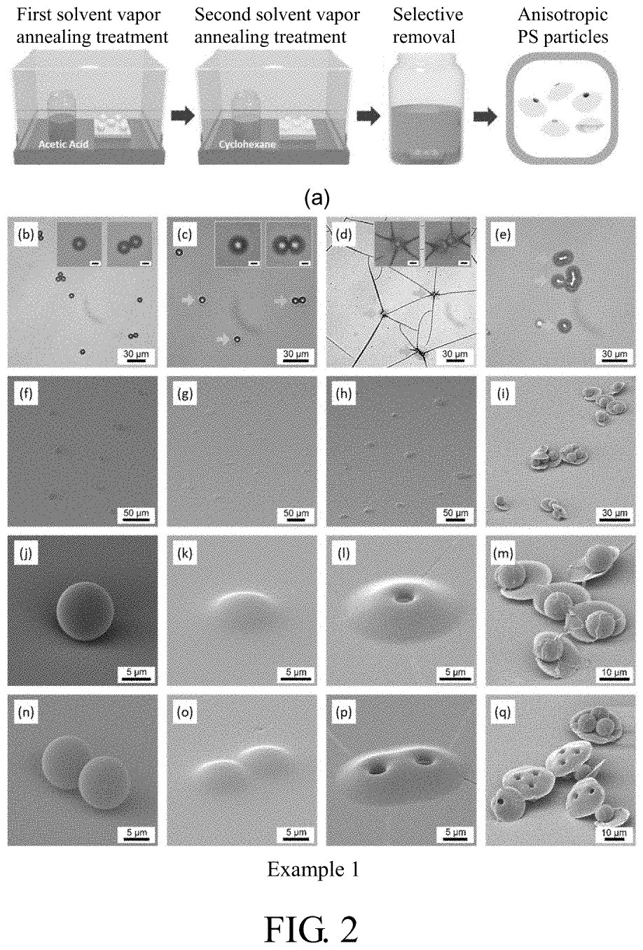

Referring to FIG. 2, as shown in graphical illustration (a), a solution of 20 wt % polymethyl methacrylate (PMMA, weight-average molecular weight (M_{w}): 75 kg/mol, purchased from Sigma-Aldrich) in toluene (purchased from Tedia) was prepared and spin-coated on a glass substrate (1.8 cm×1.8 cm, purchased from Matsunami Glass Ind., Ltd.) at 1000 rpm for 60 seconds to form a PMMA film-coated glass substrate. The PMMA film-coated glass substrate was then annealed at 150° C. for 1.5 hours to decrease roughness of the PMMA film. The thickness of the PMMA film was measured to be about 8 μm. Subsequently, an aqueous suspension of 2.6 wt % polystyrene (PS) microspheres (a mean diameter: about 10 μm, obtained from Polysciences) was diluted with ethanol (obtained from Echo Chemical) and spin-coated on the PMMA film-coated glass substrate at 1000 rpm for 1 minute to form a PS/PMMA composite, which was then dried.

An open bottle containing acetic acid was placed in a sealed glass chamber for 12 hours. The PS/PMMA composite together with the glass substrate was then placed in the glass chamber. A first vapor annealing treatment was conducted at 30° C. in a vapor atmosphere of acetic acid for 12 hours. The PS/PMMA composite together with the glass substrate was removed from the annealing chamber, followed by drying at room temperature to remove residual acetic acid therefrom.

The PS/PMMA composite together with the glass substrate was again placed in the glass chamber that contained an open bottle of cyclohexane. A second vapor annealing treatment was carried out at 30° C. in a vapor atmosphere of cyclohexane for 12 hours. The PS/PMMA composite together with the glass substrate was then taken out from the annealing chamber and dried at room temperature to remove residual cyclohexane therefrom.

The PS/PMMA composite together with the glass substrate was dipped in acetic acid for 48 hours to remove PMMA so as to obtain anisotropic PS particles.

Morphologies of the PS/PMMA composite before the first and second vapor annealing treatments, at the end of the first vapor annealing treatment conducted for 12 hours, and at the end of the second vapor annealing treatment conducted for 12 hours, and morphologies of the anisotropic PS particles thus obtained were examined using a Zeiss optical microscope (OM) and a JEOL scanning electron microscope (SEM, JSM-7401F) with accelerating voltage of 5 kV. Before examinations, the sample was dried using a vacuum pump and coated with a platinum film with a thickness of about 4 nm.

The results are shown in FIG. 2.

### Example 2

The procedures of Example 1 were repeated except that the second vapor annealing treatment was carried out for 3 hours, instead of 12 hours.

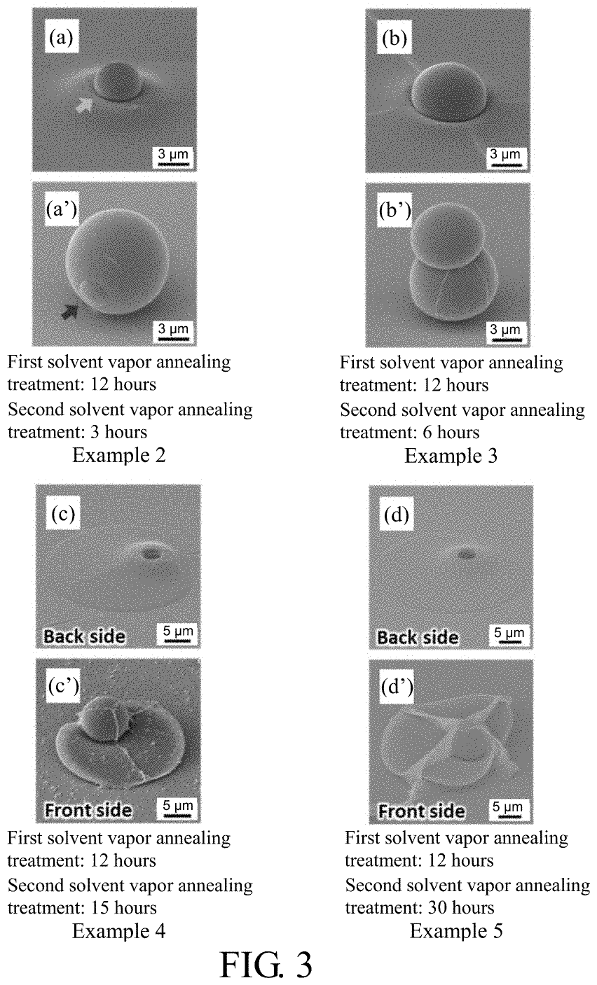

Morphology of the PS/PMMA composite after the first vapor annealing treatment conducted for 12 hours and the second vapor annealing treatment conducted for 3 hours, and morphology of the anisotropic PS particles thus obtained were examined using the JEOL scanning electron microscope (SEM, JSM-7401F). The results are shown in FIG. 3.

### Example 3

The procedures of Example 1 were repeated except that the second vapor annealing treatment was carried out for 6 hours, instead of 12 hours.

Morphology of the PS/PMMA composite after the first vapor annealing treatment conducted for 12 hours and the second vapor annealing treatment conducted for 6 hours, and morphology of the anisotropic PS particles thus obtained were examined using the JEOL scanning electron microscope (SEM, JSM-7401F). The results are shown in FIG. 3.

### Example 4

The procedures of Example 1 were repeated except that the second vapor annealing treatment was carried out for 15 hours, instead of 12 hours.

Morphology of the PS/PMMA composite after the first vapor annealing treatment conducted for 12 hours and the second vapor annealing treatment conducted for 15 hours, and morphology of the anisotropic PS particles thus obtained were examined using the JEOL scanning electron microscope (SEM, JSM-7401F). The results are shown in FIG. 3.

### Example 5

The procedures of Example 1 were repeated except that the second vapor annealing treatment was carried out for 30 hours, instead of 12 hours.

Morphology of the PS/PMMA composite after the first vapor annealing treatment conducted for 12 hours and the second vapor annealing treatment conducted for 30 hours, and morphologies of the anisotropic PS particles thus obtained were examined using the JEOL scanning electron microscope (SEM, JSM-7401F). The results are shown in FIG. 3.

### Example 6

The procedures of Example 1 were repeated except that the first vapor annealing treatment was carried out for 3 hours, instead of 12 hours.

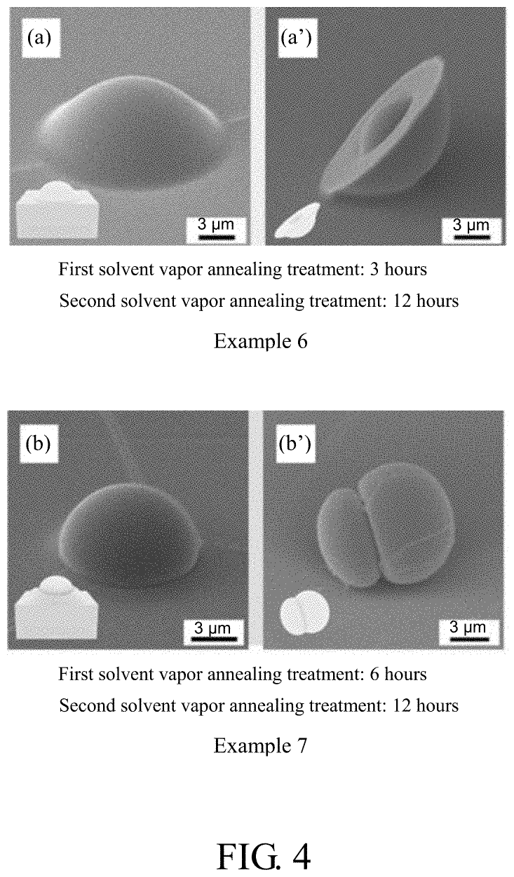

Morphology of the PS/PMMA composite after the first vapor annealing treatment conducted for 3 hours and the second vapor annealing treatment conducted for 12 hours, and morphology of the anisotropic PS particles thus obtained were examined using the JEOL scanning electron microscope (SEM, JSM-7401F). The results are shown in FIG. 4.

### Example 7

The procedures of Example 1 were repeated except that the first vapor annealing treatment was carried out for 6 hours, instead of 12 hours.

Morphology of the PS/PMMA composite after the first vapor annealing treatment conducted for 6 hours and the second vapor annealing treatment conducted for 12 hours, and morphology of the anisotropic PS particles thus obtained were examined using the JEOL scanning electron microscope (SEM, JSM-7401F). The results are shown in FIG. 4.

### Comparative Example 1

The PS microspheres were first annealed in a vapor atmosphere of acetic acid for 12 hours. The PMMA film was formed by spin-coating to obtain a polymeric composite, in which the PS microspheres were completely covered by the PMMA film. The polymeric composite was subjected to a first solvent vapor annealing treatment in the vapor atmosphere of acetic acid for 12 hours, followed by a second solvent vapor annealing treatment in a vapor atmosphere of cyclohexane for 12 hours. After that, the PMMA film was selectively removed using acetic acid, so as to obtain PS particles.

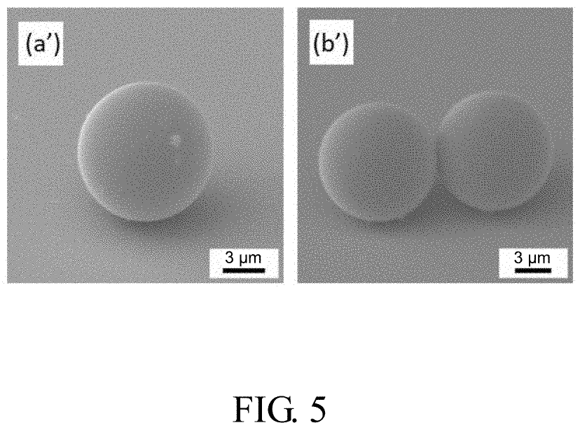

The PS particles thus obtained were examined using the JEOL scanning electron microscope (SEM, JSM-7401F). The results are shown in FIG. 5.

As shown in OM images of FIG. 2, before the first and second solvent vapor annealing treatments, only circles are observed in OM image (b) because of the optical contrast between the PS microspheres and the PMMA film. At the end of the first solvent vapor annealing treatment in the vapor atmosphere of acetic acid conducted for 12 hours, two concentric circles can be observed in OM image (c) because of the additional contrast from the climbed PMMA film around the PS microspheres. At the end of the second solvent vapor annealing treatment in the vapor atmosphere of cyclohexane conducted for 12 hours, circles with lighter corona parts can be observed while cracks are also formed in OM image (d), mainly due to the stress induced by the swollen PS microparticles that are confined in the PMMA film. The anisotropic PS particles can be released after the PMMA film is selectively removed by acetic acid, as shown in OM image (e). It can be seen in OM image (e) that the anisotropic bowler-hat-shaped PS particles with larger visor parts are formed after the first and second solvent vapor annealing treatments.

Furthermore, as shown in SEM images (f) to (q) of FIG. 2, there are no changes in the PS microspheres before the first and second solvent vapor annealing treatments, and the diameters thereof are about 10 μm, as shown in SEM image (f), (j), and (n). At the end of the first solvent vapor annealing treatment conducted for 12 hours, the wetted, volcano-shaped PMMA film can be seen around the PS microspheres, as shown in SEM images (g), (k), and (o). At the end of the second solvent vapor annealing treatment conducted for 12 hours, the PS particles can cover back the PMMA film, which reveals holes of the PS particles, as shown in SEM images (h), (l), and (p). After the PMMA film is selectively removed by acetic acid, the anisotropic bowler-hat-shaped PS particles with crown and visor parts can be released, as shown in SEM images (i), (m), and (q).

In addition, the PS microspheres may aggregate together, as shown in SEM image (n), in which PMMA starts to wet the neighboring PS microspheres at the end of the first solvent vapor annealing treatment conducted for 12 hours, resulting in formation of a double volcano-shaped PMMA film, as shown in SEM image (o). At the end of the second solvent vapor annealing treatment conducted for 12 hours, the aggregated PS microspheres can cover back the PMMA film, generating PS particles with twin holes, as shown in SEM image (p). After the PMMA film is selectively removed by acetic acid, the anisotropic bowler-hat-shaped PS particles formed from single, double, or even triple PS microspheres can be observed, as shown in SEM image (q).

For the anisotropic PS particles of Example 2, a small protrusion formed on the anisotropic PS particles, which is indicated by an arrow in image (a′) of FIG. 3, corresponds to a bump structure on top of the PMMA film, which is indicated by an arrow in image (a) of FIG. 3.

For the anisotropic PS particles of Example 3, they are of a snowman-shaped morphology, as shown in image (b′) of FIG. 3.

For the anisotropic PS particles of Examples 4 and 5, they are of a bowler-hat-shaped morphology, as shown in images (c′) and (d′) of FIG. 3.

For the anisotropic PS particles of Example 6, they are of a half-eaten-peach-shaped morphology, as shown in image (a′) of FIG. 4.

For the anisotropic PS particles of Example 7, they are of a snowman-shaped morphology, as shown in image (b′) of FIG. 4.

For the PS particles of Comparative Example 1, they maintain a spherical shape, as shown in images (a′) and (b′) of FIG. 5, indicating that the PS microspheres cannot be transformed when they are covered completely by the PMMA film.

In view of the aforesaid, the method for manufacturing anisotropic polymer particles according to the disclosure can successfully prepare anisotropic polymer particles having unique and complicated shapes, such as half-eaten-peach-shaped, snowman-shaped, and bowler-hat-shaped morphologies. The strategy of using vapors of the first and second solvents can solve thermal degradation problem of polymers at elevated annealing temperatures, which is often encountered in prior art.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for manufacturing anisotropic polymer particles, comprising the steps of:
a) preparing on a substrate a polymeric composite which includes a film of a first polymer formed on the substrate and a plurality of microspheres of a second polymer deposited on the film of the first polymer, the second polymer being different from the first polymer;
b) subjecting the polymeric composite on the substrate to a first solvent vapor annealing treatment in a vapor atmosphere of a first solvent, which is a solvent for the first polymer and which is a non-solvent for the second polymer, to permit the first polymer to swell and partially cover the microspheres of the second polymer; and
c) after step b), subjecting the polymeric composite on the substrate to a second solvent vapor annealing treatment in a vapor atmosphere of a second solvent, which is a solvent for the second polymer and which is a non-solvent for the first polymer, to permit the second polymer to swell and cover back the film of the first polymer, so as to transform the microspheres of the second polymer into the anisotropic polymer particles.

2. The method for manufacturing anisotropic polymer particles according to claim 1, further comprising a step of dissolving the first polymer with a third solvent to remove the film of the first polymer so as to obtain the anisotropic polymer particles.

3. The method for manufacturing anisotropic polymer particles according to claim 1, wherein the first polymer and the second polymer are independently selected from the group consisting of polystyrene, polymethyl methacrylate, polylactide, polycaprolactone, polyvinylpyrrolidone, poly(lactic-co-glycolic acid), and combinations thereof.

4. The method for manufacturing anisotropic polymer particles according to claim 3, wherein the first polymer is polymethyl methacrylate and the second polymer is polystyrene.

5. The method for manufacturing anisotropic polymer particles according to claim 1, wherein step a) is implemented by one selected from the group consisting of evaporation, spin coating, blade coating, spray coating, slot die coating, inject coating, and combinations thereof.

6. The method for manufacturing anisotropic polymer particles according to claim 1, wherein the microspheres of the second polymer are prepared by one selected from the group consisting of emulsion polymerization, dispersion polymerization, suspension polymerization, microfluidics, non-solvent precipitation, templating, electrospraying, thermospraying, and combinations thereof.

7. The method for manufacturing anisotropic polymer particles according to claim 1, wherein in step a), the microspheres of the second polymer deposited on the film of the first polymer are arranged in a pattern selected from the group consisting of a discrete sphere pattern, a single-layered aggregated sphere array, and a multi-layered aggregated sphere array.

8. The method for manufacturing anisotropic polymer particles according to claim 1, wherein in step a), the film of the first polymer has a thickness ranging from 10 nm to 100 μm.

9. The method for manufacturing anisotropic polymer particles according to claim 1, wherein in step a), the microspheres of the second polymer have an average size ranging from 10 nm to 100 μm.

10. The method for manufacturing anisotropic polymer particles according to claim 1, wherein in step a), the substrate is selected from the group consisting of a glass substrate, a silicon substrate, and a combination thereof.

11. The method for manufacturing anisotropic polymer particles according to claim 1, wherein each of the first and second solvent vapor annealing treatments is implemented in a chamber.

12. The method for manufacturing anisotropic polymer particles according to claim 1, wherein the first solvent is selected from the group consisting of acetic acid, diethyl sulfate, nitroethane, ethanolamine, and combinations thereof.

13. The method for manufacturing anisotropic polymer particles according to claim 1, wherein the second solvent is selected from the group consisting of cyclohexane, n-octane, n-dodecane, methylcyclohexane, benzene, o-xylene, ethyl benzene, and combinations thereof.

14. The method for manufacturing anisotropic polymer particles according to claim 2, wherein the third solvent is selected from the group consisting of acetic acid, diethyl sulfate, nitroethane, ethanolamine, and combinations thereof.

15. The method for manufacturing anisotropic polymer particles according to claim 12, wherein the first solvent is acetic acid.

16. The method for manufacturing anisotropic polymer particles according to claim 13, wherein the second solvent is cyclohexane.

17. The method for manufacturing anisotropic polymer particles according to claim 14, wherein the third solvent is acetic acid.

18. The method for manufacturing anisotropic polymer particles according to claim 1, wherein in step b), the first solvent vapor annealing treatment is implemented at a first annealing temperature ranging from 0° C. to 150° C. for a first annealing time period of up to 48 hours.

19. The method for manufacturing anisotropic polymer particles according to claim 1, wherein in step c), the second solvent vapor annealing treatment is implemented at a second annealing temperature ranging from 0° C. to 150° C. for a second annealing time period of up to 48 hours.
